(19) United States
(12) Patent Application Publication
(10) Pub. No.: US 2026/0310718 A1
(43) Pub. Date: Oct. 8, 2026

(54) Interactive Timeline Visualization of Multimedia Metadata for Enhanced Content Analysis and Exploration

(71) Applicant: Clipto, Inc., Redwood, CA (US)

(72) Inventor: Hongwen Kang, Redwood City, CA (US)

(21) Appl. No.: 19/170,893

(22) Filed: Apr. 4, 2025

(51) Int. Cl. G06F 16/44; G06F 16/45

(52) U.S. Cl. CPC G06F 16/44; G06F 16/45

(57) ABSTRACT

A method and system for visualizing and presenting multimedia data, executed by machine-readable instructions on a digital processor. It includes receiving multimedia data input and performing content analysis to extract relevant features. Based on the analysis, it generates metadata and determines a first presentation modality for displaying the multimedia content within a two-dimensional interface. It further identifies and presents one or more metadata elements for user selection. Upon receiving a user selection of a first metadata element, it adjusts the presentation of multimedia information in the interface according to the selected metadata and the determined modality. This approach enhances user interaction and content organization, enabling efficient and intuitive multimedia exploration.

### FIELD OF THE INVENTION

The present Application relates to multimedia data visualization and analysis, more particular to the presentation of high-dimensional multimedia content in a comprehensible 2D layout.

### BACKGROUND OF THE INVENTION

AI-powered tools are available today that specialize in video extraction and transcription, catering to different needs such as content creation, meeting documentation, and accessibility. These tools leverage machine learning and natural language processing (NLP) to convert spoken words into text, often providing additional features such as speaker identification, editing, and even real-time translation.

For a typical AI-powered such tool, a user must upload a video or audio file from the user's computing device (e.g., his/her laptop) into cloud storage of the tool over the internet. The tool then transcribes the spoken words in the video or audio file using AI-powered speech recognition service, which resides in a backend of the tool-remote from the user. This transcript then is sent to the user's computing device and appears in a text editor on the user's computing device, where each word is synchronized with the corresponding part of the media. From here, users can edit their content by simply modifying the text—deleting a word from the transcript removes it from the video or audio, while rearranging sentences adjusts the sequence of the media.

### SUMMARY OF THE INVENTION

In various embodiments, a method for visualizing and presenting multimedia data is provided. This method is carried out using machine-readable instructions that, when executed by a digital processor, cause the processor to perform specific actions.

First, the method involves receiving multimedia data input. Processed content is generated using the multimedia data. Content analysis is then performed on processed content. Based on the content analysis, metadata is generated. The method then determines a first modality for presenting the multimedia data in a two-dimensional interface. The method also determines one or more metadata for presentation in the two-dimensional interface, offering these to the user for selection in the two-dimensional interface. After the user selects first metadata from the one or more metadata options presented in the two-dimensional interface, the method presents information in the two-dimensional interface according to both the first modality and first metadata.

In some embodiments, a second modality for presenting the multimedia data is determined within the two-dimensional interface. In some embodiments, the second modality is selected by a user to replace the first modality for presentation of the multimedia. In some embodiments, the second modality is selected by the user in addition to the first modality for presentation. This determination is based on the metadata generated from the content analysis. Then, the information presented in the two-dimensional interface is displayed according to the first modality, the second modality, and the first metadata.

In some embodiments, the method involves receiving a user selection of second metadata from the one or more metadata presented in the two-dimensional interface. Then, the presentation of the information in the two-dimensional interface is rendered according to the first modality, the first metadata, and the second metadata.

In some embodiments, the method includes receiving a user selection of a first space in the two-dimensional interface. Based on this selected space, the method determines a corresponding time point in the multimedia data input. The presentation of information in the two-dimensional interface is then rendered according to the first modality, the first metadata, and the time point. This interaction enables dynamic exploration and filtering. The timeline-based visualization uses a timeline-centric framework. When a user interacts with a specific area on the visual display, the system identifies the related moment in the multimedia content and adjusts the presented information accordingly. The goal is to convert abstract metadata into an intuitive, human-readable format, allowing users to focus on particular aspects of the data.

The foregoing, together with other features and embodiments, will become more apparent upon referring to the following specification, claims, and accompanying drawings.

### BRIEF DESCRIPTION OF THE DRAWINGS

FIG. 1 illustrates generally an example system configured to implement an example method for visualizing and presenting multimedia data in accordance with the present disclosure.

FIG. 2 illustrates generally a flow of interaction between system components shown in FIG. 1.

FIG. 3 illustrates a method for visualizing and presenting multimedia data by the system shown in FIG. 1

FIG. 4 illustrates an example two-dimensional interface configured to present the multimedia data in accordance with the present disclosure.

FIG. 5 illustrates conceptually time-space relationships among various modalities and metadata for facilitating the presentation shown in FIG. 4.

FIG. 6 illustrates an example computer system configured to implement various embodiments according to the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed. For a particular repeated reference numeral, cross-reference may be made for its structure and/or function described and illustrated herein.

In various embodiments, a system and method for visualizing and presenting multimedia data in an intuitive and interactive manner are provided. In those embodiments, the multimedia visualization and presentation process begins with receiving multimedia data input and then performing content analysis on the multimedia data. Based on the content analysis, metadata is generated. A first modality for presenting the multimedia data in a two-dimensional interface is then determined for presenting the multimedia in a two-dimensional interface to the user.

In those embodiments, one or more metadata for presentation in the two-dimensional interface are also determined, allowing for user selection. Upon receiving a user selection of specific metadata, information is presented in the two-dimensional interface according to the first modality and the selected metadata. This allows for a tailored view of the multimedia data, where the user's choices directly influence the displayed content. The presentation of information can be further refined by incorporating user selections of metadata to influence the displayed information.

In some embodiments, a second modality is also obtained for presentation in the two-dimensional interface based on the metadata. The information presented is then displayed according to the first modality, the second modality, and the first metadata. This means that the presentation combines these elements to provide a more filtered and tailored view of the multimedia data. Still in some embodiments, a time point is determined in the multimedia data based on user selected space in the two-dimensional space. The presentation of information in the two-dimensional interface is rendered according to the first modality, the first metadata, and the time point.

Various embodiments provide numerous benefits for visualizing and presenting multimedia data. Users can tailor their experience by selecting specific metadata and modalities, resulting in enhanced understanding and engagement. By enabling users to select a space within the two-dimensional interface and determine a corresponding time point, dynamic content exploration is allowed for the user.

This timeline-based multimedia metadata visualization pattern provides a more comprehensive view of the content by incorporating multiple modalities based on the generated metadata. Abstract metadata is converted into an intuitive, human-readable format, and a timeline-centric approach turns high-dimensional data into comprehensible insights. This enhances the interpretability of complex metadata and separates the presentation methodology from specific implementation technologies, ensuring long-term adaptability and allowing for varying methods of analysis and metadata extraction.

Several issues in the interpretation and presentation of high-dimensional multimedia data are addressed by the present disclosure. One is that high-dimensional multimedia data is inherently challenging to interpret, and the present disclosure addresses this by converting abstract metadata into an intuitive, human-readable format. A timeline-centric approach transforms complex data into comprehensible insights, improving the interpretability of complex metadata.

Various embodiments can handle multimedia content of various types, including video, audio, and immersive formats like VR/AR. They organize and align metadata along temporal and contextual dimensions. Traditional approaches often lack an intuitive method to present such data cohesively, which the present disclosure solves by using a timeline-oriented 2D format to enhance accessibility. The present disclosure also tackles the challenge of harmonizing multi-modal data for human interpretation and are capable of handling extensive datasets due to their modular architecture, which is designed for scalability and maintainability

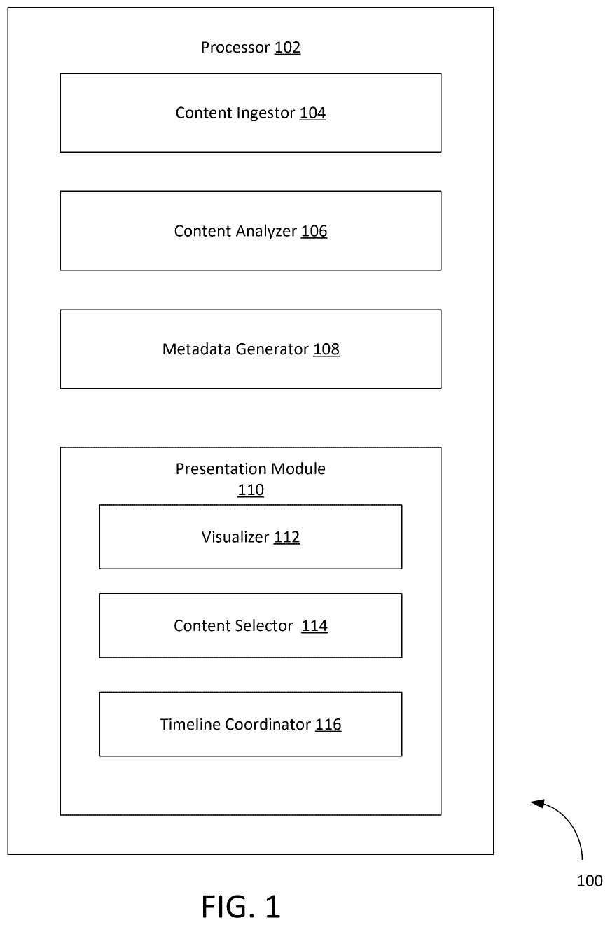

With the visualizing and presentation of multimedia data in accordance with the present disclosure having been generally described, attention is not directed to FIG. 1, where an example system configured to implement an example method for visualizing and presenting multimedia data in accordance with the present disclosure is shown.

### Example System

FIG. 1 illustrates generally an example system configured to implement an example method for visualizing and presenting multimedia data in accordance with the present disclosure. As can be seen, in this example, system 100 includes a processor 102. In various embodiments, the processor 102 may have an arithmetic logic unit (ALU), a control unit, and memory interfaces. In those embodiments, the processor 102 executes computer programs stored in memory, performing arithmetic, logic, and control operations. The ALU processes data based on control signals, while the control unit manages instruction flow and execution. The processor includes one or more registers for temporary data storage and a clock circuit to synchronize operations. It interfaces with external memory and peripheral devices via a data bus, address bus, and control bus. The processor may support multiple instruction sets, pipeline execution, and power management features to optimize performance and efficiency. In some embodiments, the processor 102 is integrated within a system-on-chip (SoC) or a microcontroller unit (MCU) for embedded applications.

In some embodiments, the computer programs executable by the processor 102 include a content ingestor 104, a content analyzer 106, a metadata generator 108, a presentation module 110, a visualizer 112, a content selector 114, and a timeline coordinator 116, and/or any other components.

The content ingestor 104 is configured to manage ingestion and preparation of multimedia content. The content ingestor 104 accepts multimedia input across diverse formats and prepares it for subsequent analytical processes performed by other components of the system 100. The content ingestor 104 receives multimedia data input including various modalities. These modalities may be categorized into audio, visual (image and video), text, sensor-based data, AR/VR data, and/or any other types of multimedia data.

In various examples, audio input is received by system 100 through microphones, sensors, or direct file uploads in formats such as MP3, WAV, AAC, FLAC, and OGG. This modality includes spoken language, music, ambient noise, and other sound-based information. It can be used for voice recognition, audio processing, and acoustic analysis in applications like virtual assistants and security systems.

Visual input may comprise images and videos, captured through cameras, scanners, or stored files. Image formats include JPEG, PNG, BMP, TIFF, and RAW, while common video formats are MP4, AVI, MKV, and MOV. These inputs enable facial recognition, computer vision, and multimedia playback, essential for surveillance, entertainment, and medical imaging applications.

Text input may be received by system 100 from typed data, scanned documents, or optical character recognition (OCR) from images. Supported formats include TXT, DOCX, PDF, and HTML, allowing structured and unstructured data processing. This modality is critical for natural language processing (NLP), search engines, and document automation.

Sensor-based input involves multimodal data such as motion tracking, infrared, LiDAR, and biometric signals. These formats may include IMU (Inertial Measurement Unit) data, thermal imaging, and EEG/ECG readings for applications in healthcare, autonomous vehicles, and augmented reality.

Augmented Reality (AR) and Virtual Reality (VR) data releis on multi-modal data to create immersive digital experiences. In various examples, AR/VR data received by system 100 may include a variety of inputs, such as visual, spatial, motion, audio, and sensor-based data, for rendering interactive environments. Visual Data plays a crucial role in AR/VR systems. AR overlays digital content onto real-world scenes using camera feeds, while VR generates fully digital environments. Formats include 3D models (OBJ, FBX, STL), 360-degree images (JPEG, PNG), and videos (MP4, MKV, MOV). Depth-sensing cameras, LiDAR, and SLAM (Simultaneous Localization and Mapping) technologies enhance spatial accuracy.

Spatial and Motion Data ensure accurate positioning and interaction in AR/VR environments. Motion tracking uses accelerometers, gyroscopes, magnetometers, and depth sensors to detect head, hand, and body movements. Data formats like IMU (Inertial Measurement Unit) and positional tracking (Vicon, OptiTrack) are critical for real-time responsiveness in headsets and controllers.

Audio Data in AR/VR enhances realism through spatialized 3D sound. Formats like AMB (Ambisonic), WAV, and MP3 provide directional audio that changes based on user movements. Advanced AR/VR applications use HRTF (Head-Related Transfer Function) processing for accurate sound localization.

Sensor-Based Data enables interactivity and environmental awareness. Hand-tracking sensors, LiDAR, depth cameras, and eye-tracking record user intent and gaze direction for natural interactions. Biometric sensors track physiological responses like heart rate (PPG, ECG) and brain activity (EEG) to enhance user experience in healthcare and training simulations.

The content analyzer 106 is configured to perform content analysis on the multimedia data input received by the system 100 via content ingestor 104, and configured to produce processed content. This may involve processing the multimedia data input using various techniques such as speech-to-text processing for audio content, recognition of facial attributes and expressions, scene decomposition and object detection within visual data, and/or any other techniques.

The metadata generator 108 is configured to generate metadata based on the content analysis performed by content analyzer 106. In various embodiments, metadata may be referred to as descriptive information generated from the data input from the content analyzer 106 to provide context, facilitate organization, and enable efficient processing. However, this is not intended to be limiting. In various other embodiments, metadata can be user-defined, or machine-generated using AI and analytics.

In various embodiments, the metadata generated by the metadata generator 108 may be organized by categories. One example of the categories may include object/person/scene recognition. For example, a category of object metadata can be generated by the metadata generator 108, which can include specific vehicles, animals, logos, landmarks, and/or any other object metadata. In that example, a given object metadata can include one or more sub-categories. For instance, animal metadata can include sub-categories such as mammals (dogs, cats, elephants), birds (eagles, parrots, owls), reptiles (snakes, turtles), amphibians (frogs, salamanders), aquatic animals (whales, sharks, fish), and insects (butterflies, bees, spiders), and/or any other sub-categories.

As another example, a person metadata category can be created by the metadata 108 to identify specific individuals based on facial recognition and biometric analysis performed by the content analyzer 106. The person metadata can include identities of celebrities, public figures, or registered users and/or any other types of person identities. In some embodiments, the metadata generator 108 can generate anonymous attribute-based person metadata instead of direct identification to protect their privacy.

In some embodiments, metadata generated by the metadata generator 108 classifies individuals based on demographics, detecting age groups (infant, child, teenager, adult, elderly), gender (male, female, non-binary), and ethnicity (if permissible by law and ethical guidelines). These attributes help in organizing video content for targeted presentation.

In some embodiments, the metadata generated by the metadata generator 108 includes appearance-based metadata allows users to search for individuals based on clothing color, accessories, and distinguishing features, such as glasses, hats, masks, uniforms, hairstyles, tattoos, and/or any other types of appearance attributes. This is particularly useful in security applications, forensic investigations, and fashion-related presentation of the multimedia data.

The presentation module 110 is configured to present the multimedia data received by the system 100 in a flexible manner that allows modality and/or metadata to be used for the presentation. As can be seen, the presentation module 110, in this example, includes a visualizer 112, a content selector 114, a timeline coordinator 116, and/or any other components.

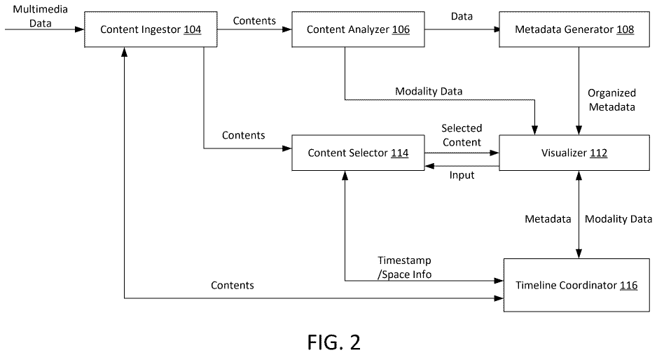

The visualizer 112 is configured to generate a two-dimensional interface for presenting the multimedia data in accordance with one or more modality and/or metadata used for the presentation. FIG. 2 illustrates one example implementation of system 100 in a data flow view, where the visualizer 112 interaction with various other components in system 100 is shown. The visualizer 112 plays a crucial role in presenting the multimedia data input received by the system 100. In some embodiments, the visualizer 112 also facilitates the presentation of the metadata generated by the metadata generator 108 to the user.

One of the visualizer 112's interactions is with the metadata generator 108, from which it receives organized metadata. As mentioned, the organized metadata is a result of content analysis performed on the multimedia data and can include various forms of extracted information like speech transcriptions, facial recognition data, and scene understanding details, as described above. The visualizer 112 uses the organized metadata as the foundation for its visual representations.

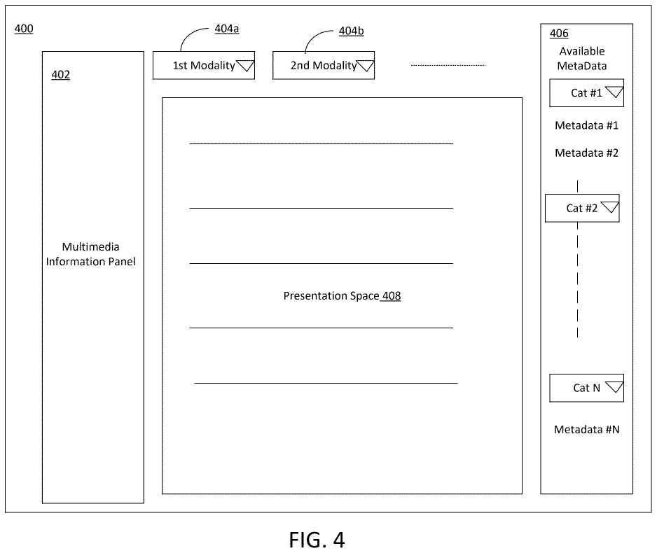

FIG. 4 illustrates an example two-dimensional interface 400 configured to present the multimedia data in accordance with the present disclosure. In various embodiments, the two-dimensional interface 400 is generated by the visualizer 112. In this example, the two-dimensional interface 400 includes a multimedia information panel 402 configured to present information about the multimedia data input received by the system 100. Multimedia information presented in the multimedia information panel 402 may be defined by various parameters. In text-based multimedia, parameters such as font type, size, and character encoding play a crucial role in readability and presentation. Other text-based multimedia information may include encoding formats like ASCII or UTF-8, line spacing, alignment, and color contrast, and/or any other text-based multimedia information.

For images, the multimedia information in the multimedia information panel 402 may include resolution and file format of the images. Formats such as JPEG, PNG, and GIF determine how an image is compressed and displayed, and may be shown in the multimedia information panel 402 when one or more images are the subject multimedia data presented in the two-dimensional interface 400. Other image-based multimedia information may include color depth, aspect ratio, compression methods, whether lossy or lossless, and/or any other types of image-based multimedia information.

Audio-based multimedia information in the multimedia information panel 402 may help understand a clarity and fidelity of sound in audio presented by the two-dimensional interface 400. Such information may include bitrate, sample rate, typically measured in kilohertz, number of audio channels, such as mono or stereo, file formats like MP3, WAV, and AAC,balancing quality with file size, and/or any other types of audio-based multimedia information.

Video-based multimedia information in the multimedia information panel 402 may help understand a quality of a video presented in the two-dimensional interface 400. Such information may include video resolution, frame rate, compression format, bitrate, compression formats like H.264 and H.265, aspect ratio and/or any other video-based multimedia information.

Animation-based multimedia information in the multimedia information panel 402 may include parameters such as frame rate, rendering techniques, and motion smoothness. A higher frame rate results in more fluid motion, while rendering methods determine the visual quality of animations. Other animation-based multimedia information may include formats and compression techniques.

Interactive multimedia information in the multimedia information panel 402 may incorporate parameters that enhance user engagement, such as response time, interactivity levels, and user interface design. The effectiveness of interactive elements depends on seamless responsiveness and intuitive navigation. Technologies like HTML5, JavaScript, and virtual reality frameworks facilitate dynamic multimedia experiences, allowing users to interact with content in real-time. These parameters ensure that multimedia data presented in two-dimensional interface 400 remains immersive, efficient, and user-friendly.

Attention is now directed to middle upper portion of the two-dimensional interface 400 where one or more modality selection menus 404 are shown. In this example, two modality selection menus 404a and 404b are shown, however this is not intended to be limiting. The number of modality selection menus shown in two-dimensional interface 400 may vary in other examples. In general, as mentioned above, multimedia data input received by the system 100 may include one or more modalities. Taking video as an example, it can include the following modalities-speech (text), audio (sound), images (still), and video. In implementation, the content ingestor 104 can be configured to receive multimedia data (e.g., video) and separate them into different types of contents (e.g., audio, video), and the content analyzer 106 can be configured to perform content analysis to generate modality data (e.g., “text”, “sound”, “still image”, “video”) and feed the modality data to the visualizer 112. This is shown in FIG. 2.

When generating the two-dimensional interface 400, the visualizer 112 can be configured to populate the modality selection menus 404 with the modality data for user selection. For instance, for presenting the video received by the system 100, the user may select a first modality to be text and second modality to be images. In this way, the user would like to view images in the video associated with texts transcribed from speech in the frames corresponding to the images. In this sense, the two-dimensional interface 400 enables the user to experience the multimedia data in a flexible manner, rather than linearly viewing it. Other combinations of the modalities for user selection may include text and audio; audio and images; text, audio, and images; and so on.

The metadata selection area 406 is configured to present the metadata generated by the metadata generator 108. As mentioned above, the metadata generator 108 feeds the metadata to the visualizer 112, which populates the metadata selection area 406 with the metadata. The metadata in the metadata selection area 406 represents various subjects or interests in the multimedia presented two-dimensional interface 400.

As an example, in a scenario where a video is received by system 100 and presented in the two-dimensional interface 400, the video contains various persons talking among themselves. The metadata generated by the metadata generator 108 for the video may include a category called “person”, where persons in the video is shown such as person #1 (metadata #1 in this example), person #2 (metadata #2), person #3 and so on are identified as through individual metadata. In the video, the interactions between the persons may occur in different buildings, and a second category of metadata called “building” identifying individual building. Another category of object metadata may be presented in the metadata selection area 406 in this example to identify different objects in the video.

The presentation space 408 in the two-dimensional interface 400 is configured to present information in the two-dimensional interface 400 according to one or more modalities and/or metadata determined or selected. As illustration, several presentation scenarios will be described below.

### One Modality or One Metadata

This presentation scenario is perhaps the simplest presentation scenario enabled by the two-dimensional interface 400. In this presentation scenario, a single modality or metadata may be determined or selected. For instance, in a video input example, the system 100 may be defaulted to show the video under the modality “video”, which is determined by the system 100 by default. In this way, by default, the video is presented in the presentation space 408 linearly (in its natural timeline).

The user may then select “Audio” as the 1^{st} modality in the modality selection menu 404a as the presentation modality for the video input. After the selection, the audio (sound) of the video is presented in the presentation space 408 instead of the video, in its natural timeline.

As mentioned, the user may also select a metadata in the metadata selection area 406 for presenting the video. For example, the user may select a metadata called “person 1” for the presentation. After the selection, video segments of person 1 is shown in the presentation space 408, in which person 1 appears. For instance, person 1 may appear in a first video segment for 15 seconds, and the first video segment is shown in presentation space 408; in a second video segment for 31 seconds, and the second video segment is shown in presentation space 408; and so on.

### Multiple Modalities

In this presentation scenario, multiple modalities are determined or selected for presentation in the two-dimensional interface 400. Still using the video input as example, the user may select “audio” as the first modality in the modality selection menu 404a, and “text” as the second modality in the modality selection menu 404b. After the selection, audio and associated text are presented in the presentation space 408. For instance, an audio clip representation may be shown in presentation space 408. After the user acts on the audio clip representation to play the audio, texts associated with the audio are automatically displayed by in the presentation space 408. The user may fast forward or rewind the audio playback, and texts associated with the audio are displayed accordingly (e.g., more texts are displayed as the audio plays forward and less texts are displayed as the audio is rewound backwards).

### Multiple Metadata

In this scenario, multiple metadata are selected by user for the presentation. For example, after person 1 and object 1 are selected by the user for the presentation, video segments where both person 1 and object 1 are in are shown presentation space 408. As another example, after person 1, person 2 and building 1 are selected, one or more video segments where person 1interacts with person 2 in building 1 are shown in presentation space 408.

### Multiple Modalities and Metadata

In this presentation scenario, one or more modalities and one or more metadata are selected for presentation. For example, as illustration, the user may select audio as the modality for presentation, and person 1 and person 2 as the metadata. After the selection, audio clips in which person 1 and person 2 are in are shown in the presentation space 408 such that the user may play them. The user may then select “text” as the second modality to see transcriptions of such audio in the presentation space 408.

Attention is now directed back to FIG. 2. Interaction among the visualizer 112, the content selector 114 and the timeline coordinator 116 are now described in view of the presentation scenarios mentioned above. The content selector 114 is configured to select content for presentation in the two-dimensional interface 400 according to the modality and/or metadata determined or selected. The timeline coordinator 116 is configured to coordinate timeline of the multimedia data input received by the system 100 and the presentation space 408 in the two-dimensional interface 400.

One insight provided by the present disclosure is that a timeline of the multimedia data may be aligned with metadata and/or modality data in the multimedia data input. Traditionally, multimedia data is presented in its natural timeline wholly-meaning all modalities and metadata identified items are presented in the multimedia linearly throughout its timeline. For example, in a video, scenes or frames of the video are presented bit by bit throughout the timeline of the video. While a user may manipulate the playback of the video by fast forwarding, adjusting play speed, skipping around the video timeline etc., it is not easy for the user to quickly view/extract information in the video of interest to the user. For example, the user may be interested in viewing all the interactions between person 1 and person 2.

As mentioned above, the present disclosure provides an interface to enable the user to achieve such a scenario. A key to this is the alignment of metadata, modalities, and/or as well as the presentation space 408 in the two-dimensional interface 400. Still using the video input as example, if the user selects “images” as the modality for presentation, every image in the video frames is then presented in the presentation space 408 in sequence. For instance, position (0, 0) of the presentation space (e.g., left most up corner) is presented with image #1 of the video frames, which corresponds to the very first time point of video. Depending on image display size in the presentation space 408, the next position after (0,0) will display the second image of the video frames and so on.

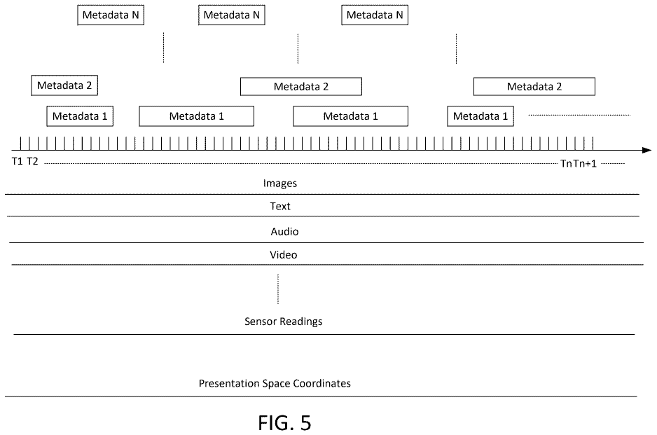

In this sense, time and presentation space are associated with each other. This may apply to other modalities of the video, such as audio, and text-as shown in FIG. 5. A key idea enabled by the two-dimensional interface 400 in accordance with the present disclosure is that this time-space association may be rearranged depending on the user's interest and request through selection of modality and/or metadata.

As illustration, if the user selects person 1 as the metadata for presenting the images in the video, that means the user is interested in view all images in the video that show person 1. The presentation in the presentation space 408, after the user's selection of the metadata person 1, is the first image of person 1 at position (0, 0) of the presentation space 408. It should be noted that the first image of person 1 in the video may not necessarily be the very first time point of the video's timeline. It may be, for example, the 10^{th} time point on the timeline of the video. In this sense, the images in the video are rearranged with the presentation space 408 after one or more metadata is selected by the user.

This concept is illustrated in FIG. 5. As can be seen, the multimedia data may have a timeline that has multiple time points or time stamps, which may represent a frequency (e.g., bit rate of audio or video) how the multimedia data is taken and/or compressed. The timeline coordinator 116 receives one or more metadata selections from the visualizer 112 and then applies time stamps to the metadata. For example, the timeline coordinator 116 receives metadata 1 (e.g., “person 1”), and metadata 2 (e.g., “person 2”) from the visualizer 112, and applies time stamps to the metadata accordingly. As illustrated in FIG. 5, four timestamps are applied to metadata 1, e.g., metadata 1 time stamp x: start: time point x; end: time point y. Similar three timestamps may be applied to metadata 2. The timeline coordinator 116 is configured to combine these timestamps to find the overlapping segments on the timeline (e.g., a portion of the vide where both person 1 and person 2 appear) and provide indications of such segments to the content selector 114.

The content selector 114 is configured to select content for presentation based on the timestamp information. Attention is directed back to FIG. 2, as can be seen, the content selector 114 receives the timestamp information from the timeline coordinator 116 and can also receive input from the visualizer 112 (e.g., one or more modalities selected by the user). Based on these, the content selector 114 is configured to select contents ingested by the content ingestor 104 for presentation in the two-dimensional interface 400. For example, the timestamp information provided by the timeline coordinator 116 includes timestamps indicating segments of the video where both person 1 and person 2 appear, and the input from the visualizer 112 indicate that the user selects “audio” as the modality for the presentation. In that scenario, the content selector 114 selects audio portion of the video where both person 1 and both person 2 appear according to the timestamp information provided by the timeline coordinator 116 and provide the selected contents to the visualizer for presentation in two-dimensional interface 400.

Another type of input from the visualizer 112 is space information regarding one or more positions in the presentation space 408. As illustration, for example, the user may first select “image” as modality and person 1 as the metadata to show all images of person 1 in the video frame in the presentation space 408. The images are displayed in the presentation space 408 sequentially according to the timeline of the video. The user may then act on one or more images presented requesting the content selector 114 to show more information about those images. For instance, the user may select images appearing in three different positions in the presentation space 408; and the content selector 114 receives the space information regarding those different positions. The content selector 114 then sends the space information to the timeline coordinator 116, which can then return the timestamp information regarding those images according to the space information received. The content selector 114 can then select contents based on the timestamp information for presentation in the two-dimensional interface 400. For instance, a default 30 second video clip starting at each time point corresponding to those images may be shown in two-dimensional interface 400. In this way, the user is enabled to quickly skip to portions of the video of interest to the user and view them in the two-dimensional interface 400.

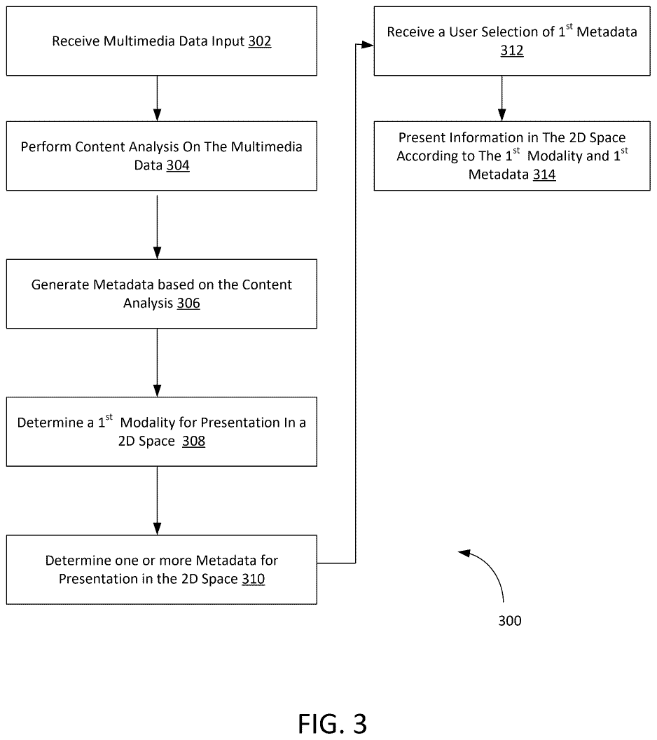

Attention is now directed to FIG. 3, where a method for visualizing and presenting multimedia data by the system shown in FIG. 1 is illustrated. The method 300 presented in FIG. 3 and described below is intended to be illustrative and non-limiting. The particular series of processing steps depicted in FIG. 3 is not intended to be limiting. It is appreciated that the processing steps may be performed in an order different from that depicted in FIG. 3 and that not all the steps depicted in FIG. 3 need be performed. In certain implementations, the method 300 may be implemented by a computer system, such as the system 100 shown in FIG. 1.

At 302, multimedia data input is received. In some implementations, operations involved in 302 may be implemented by content ingestor similar to the content ingestor 104 described and illustrated herein.

At 304, content analysis is performed on the multimedia data received at 302. In some implementations, operations involved in 304 may be implemented by content analyzer similar to the content analyzer 106 described and illustrated herein.

At 306, one or more metadata is generated based on the content analysis performed at 304. In some implementations, operations involved in 306 may be implemented by metadata generator similar to the metadata generator 108 described and illustrated herein.

At 308, a first modality of the multimedia data is determined for presentation in a two-dimensional interface. This determination may be made by a system such as system 100, for example, as configured by a super user. For instance, a default modality for presenting video input may be configured as “video” such that video is initially presented to the user when a video input is received at 302. However, this determination may also be made by the user. For example, after the initial presentation of the video input, the user may select “audio” as the modality for presentation such that only audio portion of the video is presented in the two-dimensional interface. In some implementations, operations involved in 308 may be implemented by a visualizer similar to the visualizer 112 described and illustrated herein.

At 310, one or more metadata may be presented in the two-dimensional interface based on the metadata generated at 306. In some implementations, operations involved in 310 may be implemented by a visualizer similar to the visualizer 112 described and illustrated herein.

At 312, a first used selected metadata may be received. In some implementations, operations involved in 312 may be implemented by a timeline coordinator similar to the timeline coordinator 116 described and illustrated herein.

At 314, information is presented in the two-dimensional interface according to the first modality and first metadata. In some implementations, operations involved in 310 may be implemented by a visualizer similar to the visualizer 112 described and illustrated herein.

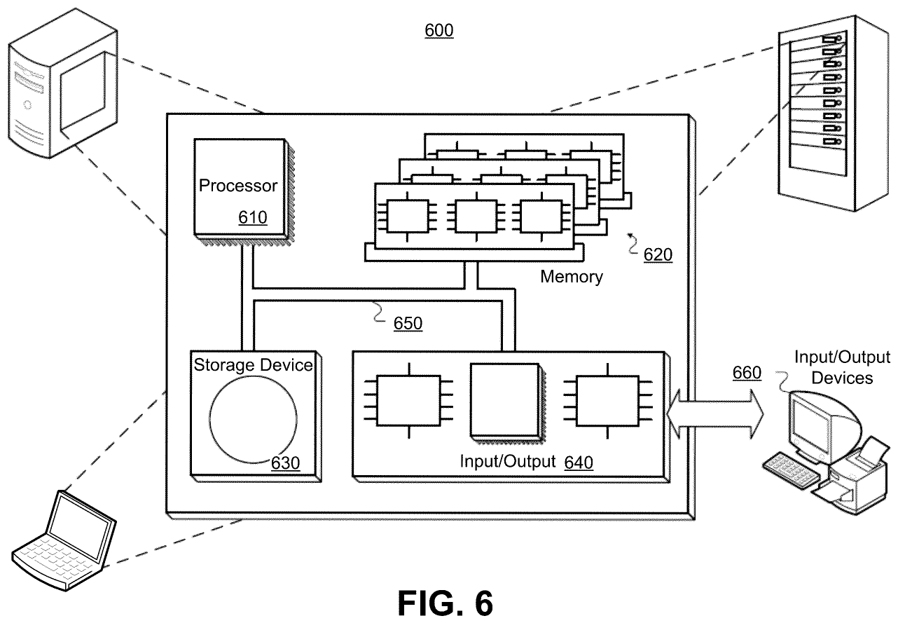

Referring to FIG. 6, a schematic diagram is shown of an example of a computer system 600. This system is exemplary only and one having skill in the art will recognize that variations and modifications are possible. The system 600 can be used for the operations described above. For example, the computer systems shown in FIG. 6 can be used to implement any or all of the initialization (e.g., face annotation, skull fitting, constraint creation) and stabilization (e.g., skin energy or error determination, nose energy or error determination) techniques and routines described herein.

The memory 620 stores information within the system 600 and can be associated with various characteristics and implementations. For example, the memory 620 may include various types of computer-readable medium such as volatile memory, a non-volatile memory and other types of memory technology, individually or in combination.

The storage device 630 is capable of providing mass storage for the system 600. In one implementation, the storage device 630 is a computer-readable medium. In various different implementations, the storage device 630 can be a floppy disk device, a hard disk device, an optical disk device, or a tape device.

The input/output device 660 provides input/output operations for the system 600. In one implementation, the input/output device 660 includes a keyboard and/or pointing device. In another implementation, the input/output device 660 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube), LCD (liquid crystal display), LED (light emitting diode) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other. Although a few implementations have been described in detail above, other modifications are possible.

In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other implementations are within the scope of the following claims.

Where components are described as being configured to perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of exemplary embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

A recitation of “a”, “an” or “the” is intended to mean “one or more” unless specifically indicated to the contrary. The use of “or” is intended to mean an “inclusive or,” and not an “exclusive or” unless specifically indicated to the contrary.

Two states are also for illustration purpose. It is possible for an embodiment where remote command and local command for changing oxygen device settings be accepted without state switches.

All patents, patent applications, publications, and descriptions mentioned herein are incorporated by reference in their entirety for all purposes. None is admitted to be prior art.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method for visualizing and presenting multimedia data, the method being implemented by machine-readable instructions using a digital processor such that when the machine-readable instructions are executed, the digital processor is caused to perform the method comprising:
receiving multimedia data input;
performing content analysis on the multimedia data input;
generating metadata based on the content analysis;
determining a first modality for presentation of the multimedia data in a two-dimensional interface based on the metadata;
determining one or more metadata for presentation in the two-dimensional interface and for user selection;
receiving a user selection of first meta from the one or more metadata presented in the two-dimensional interface; and
presenting information in the two-dimensional interface according to the first modality and first metadata.

2. The method for visualizing and presenting multimedia data of claim 1, wherein the method further comprises: determining a second modality for presentation of the multimedia data in a two-dimensional interface based on the metadata, and the presentation of the information in the two-dimensional interface is according to the first modality, the second modality and the first metadata.

3. The method for visualizing and presenting multimedia data of claim 1, wherein the method further comprises: receiving a user selection of second meta from the one or more metadata presented in the two-dimensional interface, and the presentation of the information in the two-dimensional interface is according to the first modality, the first and the second metadata.

4. The method for visualizing and presenting multimedia data of claim 1, wherein the method further comprises:
receiving a user selection of second meta from the one or more metadata presented in the two-dimensional interface; and
determining a second modality for presentation of the multimedia data in a two-dimensional interface based on the metadata; and, wherein the presentation of the information in the two-dimensional interface is according to the first and second modalities, and the first and the second metadata.

5. The method for visualizing and presenting multimedia data of claim 1, wherein the metadata comprises first metadata and the method further comprises:
applying timestamps to the first metadata, wherein the timestamps include a first timestamp and a second timestamp.

6. The method for visualizing and presenting multimedia data of claim 5, wherein the metadata comprises second metadata, and the method further comprises:
applying timestamps to the second metadata; and, wherein the first and second metadata overlap at least in time according to the first timestamp and the second timestamp.

7. The method for visualizing and presenting multimedia data of claim 1, further comprising organizing the one or more metadata into one or more categories, and presenting the one or more metadata in the two-dimensional interface according to the one or more categories.

8. The method for visualizing and presenting multimedia data of claim 1, wherein the method further comprises:
receiving user selection of a first space in the two-dimensional interface; and
determining a time point in the multimedia data input based on the first space in the two-dimensional interface; and, wherein presenting information in the two-dimensional interface according to the first modality, first metadata and the time point.

9. A system for visualizing and presenting multimedia data, the system comprising a digital processor configured to execute machine-readable instructions such that when the machine-readable instructions are executed, the digital processor is caused to perform:
receiving multimedia data input;
performing content analysis on the multimedia data input;
generating metadata based on the content analysis;
determining a first modality for presentation of the multimedia data in a two-dimensional interface based on the metadata;
determining one or more metadata for presentation in the two-dimensional interface and for user selection;
receiving a user selection of first meta from the one or more metadata presented in the two-dimensional interface; and
presenting information in the two-dimensional interface according to the first modality and first metadata.

10. The system for visualizing and presenting multimedia data of claim 9, wherein the method further comprises: determining a second modality for presentation of the multimedia data in a two-dimensional interface based on the metadata, and the presentation of the information in the two-dimensional interface is according to the first modality, the second modality and the first metadata.

11. The system for visualizing and presenting multimedia data of claim 9, wherein the method further comprises: receiving a user selection of second meta from the one or more metadata presented in the two-dimensional interface, and the presentation of the information in the two-dimensional interface is according to the first modality, the first and the second metadata.

12. The system for visualizing and presenting multimedia data of claim 9, wherein the method further comprises:
receiving a user selection of second meta from the one or more metadata presented in the two-dimensional interface; and
determining a second modality for presentation of the multimedia data in a two-dimensional interface based on the metadata; and, wherein the presentation of the information in the two-dimensional interface is according to the first and second modalities, and the first and the second metadata.

13. The system for visualizing and presenting multimedia data of claim 9, wherein the metadata comprises first metadata and the method further comprises:
applying timestamps to the first metadata, wherein the timestamps include a first timestamp and a second timestamp.

14. The system for visualizing and presenting multimedia data of claim 13, wherein the metadata comprises second metadata, and the method further comprises:
applying timestamps to the second metadata; and, wherein the first and second metadata overlap at least in time according to the first timestamp and the second timestamp.

15. The system for visualizing and presenting multimedia data of claim 9, further comprising organizing the one or more metadata into one or more categories, and presenting the one or more metadata in the two-dimensional interface according to the one or more categories.

16. The system for visualizing and presenting multimedia data of claim 9, wherein the method further comprises:
receiving user selection of a first space in the two-dimensional interface; and
determining a time point in the multimedia data input based on the first space in the two-dimensional interface; and, wherein presenting information in the two-dimensional interface according to the first modality, first metadata and the time point.
